(19) United States
(12) Patent Application Publication
(10) Pub. No.: US 2009/0319330 A1
(43) Pub. Date: Dec. 24, 2009

(54) TECHNIQUES FOR EVALUATING RECOMMENDATION SYSTEMS

(75) Inventors: Ioan Bogdan Crivat, Redmond, WA (US); C. James MacLennan, Redmond, WA (US); Yue Liu, Bellevue, WA (US); Michael D. Moore, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/141,105

(22) Filed: Jun. 18, 2008

(51) Int. Cl. G06Q 10/00

(52) U.S. Cl. 705/10; 705/7

(57) ABSTRACT

Various technologies and techniques are disclosed for calculating and evaluating the behavior of recommendation systems. Accuracy measures are computed for a plurality of items in a real recommendation system, an ideal recommendation system, and a popularity-based baseline recommendation system. The accuracy measures for the plurality of items are presented to a user so the user can evaluate a performance of the real recommendation system in comparison to the ideal recommendation system and the popularity-based baseline recommendation system. The accuracy measures can be presented in an interactive graph.

### BACKGROUND

A recommendation system is an information filtering system that uses a user's profile to make inferences about other goods and/or services that are likely to be interesting for a user. For example, the user's demographic information and/or history of previous purchases can be used to recommend other products that the user may want to consider purchasing. Recommendations systems often used by ecommerce stores that sell goods over the Internet in order to increase the volume of sales.

Recommendation systems are typically based on statistical inference engines. Describing the behavior and evaluating the accuracy of a recommendation system can be a complex task, since recommendation systems typically produce large sets of rules or inference patterns which can be hard to present in an intuitive form.

### SUMMARY

Various technologies and techniques are disclosed for calculating and evaluating the behavior of recommendation systems. Accuracy measures are computed for a plurality of items in a real recommendation system, an ideal recommendation system, and a popularity-based baseline recommendation system. The accuracy measures for the plurality of items are presented to a user so the user can evaluate a performance of the real recommendation system in comparison to the ideal recommendation system and the popularity-based baseline recommendation system. The accuracy measures can be presented in an interactive graph.

In one implementation, techniques for generating an interactive graph that can be used by a user to conduct a performance evaluation of a real recommendation system are described. Accuracy measures are computed for a plurality of items in a real recommendation system, an ideal recommendation system, and a popularity-based baseline recommendation system. An interactive graph is generated in descending order by the accuracy measures for the plurality of items in the real recommendation system, the ideal recommendation system, and the popularity-based baseline recommendation system. The graph is displayed so a user can interact with the graph to conduct a performance evaluation of the real recommendation system in comparison to the ideal recommendation system and the popularity-based baseline recommendation system.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a system for evaluating recommendation systems of one implementation.

FIG. 2 is a process flow diagram for one implementation illustrating the high level stages involved in calculating measures for multiple recommendation systems so they can be compared.

FIG. 3 is a process flow diagram for one implementation illustrating the stages involved in using past sales of all customers to assist in generating accuracy metrics for a recommendation system.

FIG. 4 is a process flow diagram for one implementation illustrating the stages involved in using new purchases by existing customers to assist in generating accuracy metrics for a recommendation system.

FIG. 5 is a process flow diagram for one implementation illustrating the stages involved in computing overall accuracy scores for recommendation systems.

FIG. 6 is a diagrammatic view for one implementation illustrating an interactive chart that presents data regarding the behavior and/or accuracy of a recommendation system as compared with other recommendation systems.

FIG. 7 is a diagrammatic view for one implementation that illustrates a chart that illustrates the evolution of the lift and coverage for a recommendation system.

FIG. 8 is a diagrammatic view of a computer system of one implementation.

### DETAILED DESCRIPTION

The technologies and techniques herein may be described in the general context as an application that evaluates the behavior and/or accuracy of a recommendation system, but the technologies and techniques also serve other purposes in addition to these.

In one implementation, techniques are described for evaluating the behavior and/or accuracy of a recommendation system. The term “recommendation system” as used herein is meant to include a mechanism for proposing a meaningful addition to a set, based on the existing set and additional information about the set. The term “item” and “items” as used herein are meant to include members of a set, such as good(s) and/or service(s). In one implementation, behavior information is collected, and the information is presented in an interactive diagram for analysis. A metric is provided that enables the performances of different recommendation systems to be compared for the same problem or data.

In general, in order to evaluate a statistical inference model used by a recommendation system, a separate data set is needed that is statistically similar with the one used in detecting the patterns. This data set is typically called “a holdout dataset” or “holdout set”. Techniques are described herein for evaluating the accuracy and behavior of one or more recommendation systems over a holdout (witness) set.

A recommendation system, as mentioned previously, can be thought of as a system which produces a fixed number of recommendations (items) for each individual user, based on the profile information of that user. The profile information generally includes a history of previous items of interest for the user (previous purchases). It may also include demographic information (attributes, such as Gender, Location etc.) of the user. The recommendation system can be thought of as a function which takes as input all the information about the user known to the system and produces (as output) a set of N recommended items.

A simple recommendation system can be implemented by simply returning the top most popular N items in the item space (in the ecommerce metaphor, this means the catalog items that generated most sales over time). In one implementation, such a basic system as a baseline to use in making comparisons with a recommendation system being evaluated.

An ideal recommendation system is a hypothetical system which produces perfect recommendations, such that all recommendations would be interesting to the end user. In one implementation of the system for evaluating recommendation systems that is described herein, the performance of any recommendation system is considered to be somewhere between the very simple system based on popularity and a hypothetical ideal system. In such an implementation, the reasons for such boundaries include the fact that (1) the performance of the ideal system cannot be exceed by definition of the ideal system; and (2) any performance worse than the popularity system may not warrant implementing a more complex system. Some techniques for evaluating recommendation systems will now be described in the figures that follow.

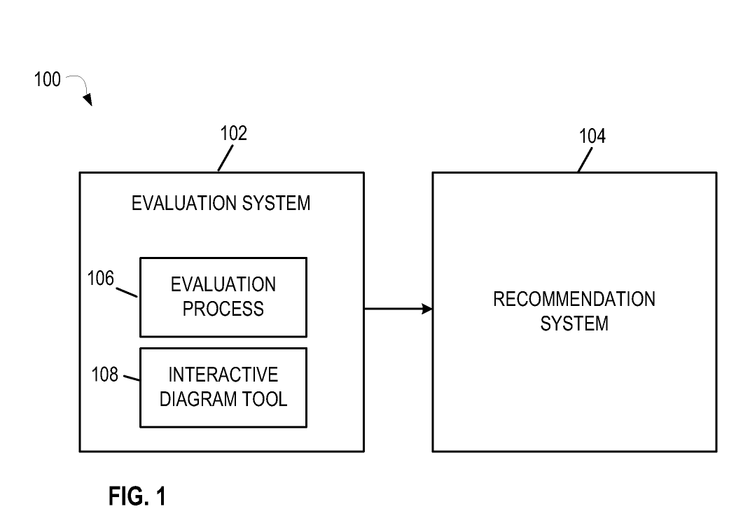

FIG. 1 is a diagrammatic view of a system 100 for evaluating recommendation systems of one implementation. System 100 includes an evaluation system 102 and recommendation system(s) 104 being evaluated. Evaluation system 102 includes an evaluation process 106 and an interactive diagram tool 108 which displays the results of the evaluation.

Evaluation process 106 is responsible for evaluating the accuracy and/or behavior of a particular recommendation system when compared to an ideal system and/or other recommendation systems. Evaluation process 106 is responsible for evaluating the performance of a recommendation system with regard to one or more measures. Such measures include: the number of correct recommendations, the cumulative value of correct recommendations, and the percent of correct recommendations. These measures can be computed individually for each item in the item space and aggregated over the holdout set.

Returning to the ecommerce metaphor, then take any product in the catalog as the example. The number of correct recommendations for a given item can be the number of times the item was recommended and the recommendation was useful. The cumulative value of correct recommendations for a given item can be the nominal value of the item times the number of times the item was recommended and the recommendation was useful. The percent of correct recommendations for a given item may be defined as the ratio (by definition, subunitary) between the number of correct recommendations generated by a system and the one generated by an ideal recommendations system.

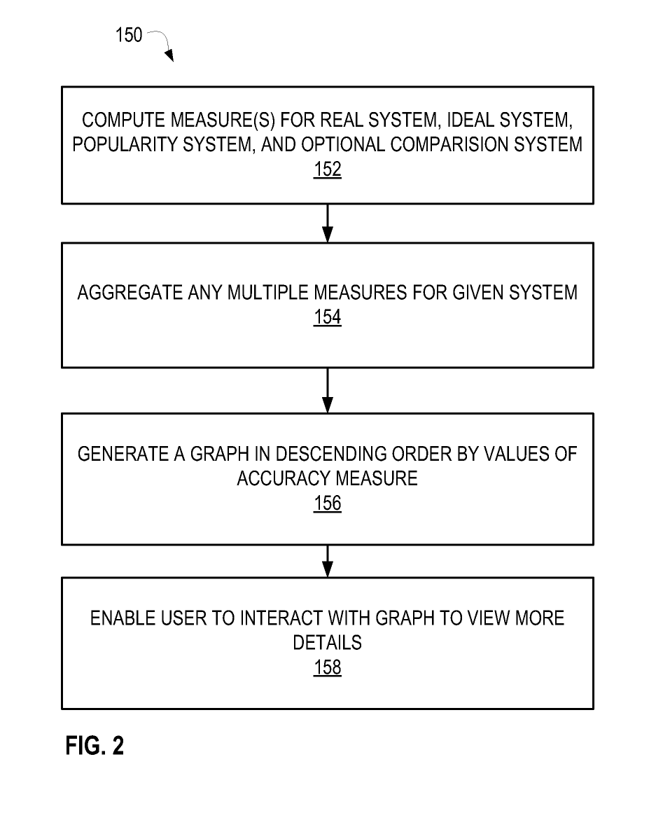

Evaluation process 106 can work with any metric that can be defined and computed for each individual item in the item space both for an arbitrary recommendation system and for an ideal system, over a holdout set. In one implementation, a measure used by evaluation process 106 also needs to satisfy the following conditions: (1) The measure only takes positive values (>=0); (2) The measure is maximized by an ideal model (for any item, the measure as computed for an arbitrary recommendation system is less or equal with the measure as computed for an ideal system); and (3) The measure is monotonically growing (i.e. if the measure computed for Recommendation System 1 for one item is larger in value than the measure computed for Recommendation System 2 for the same item, then Recommendation System 1 produces better accuracy than Recommendation System 2 for that particular item). In other implementations, some or all of the above conditions do not have to be met. The evaluation process 106 is described in further detail in FIGS. 2-5 herein.

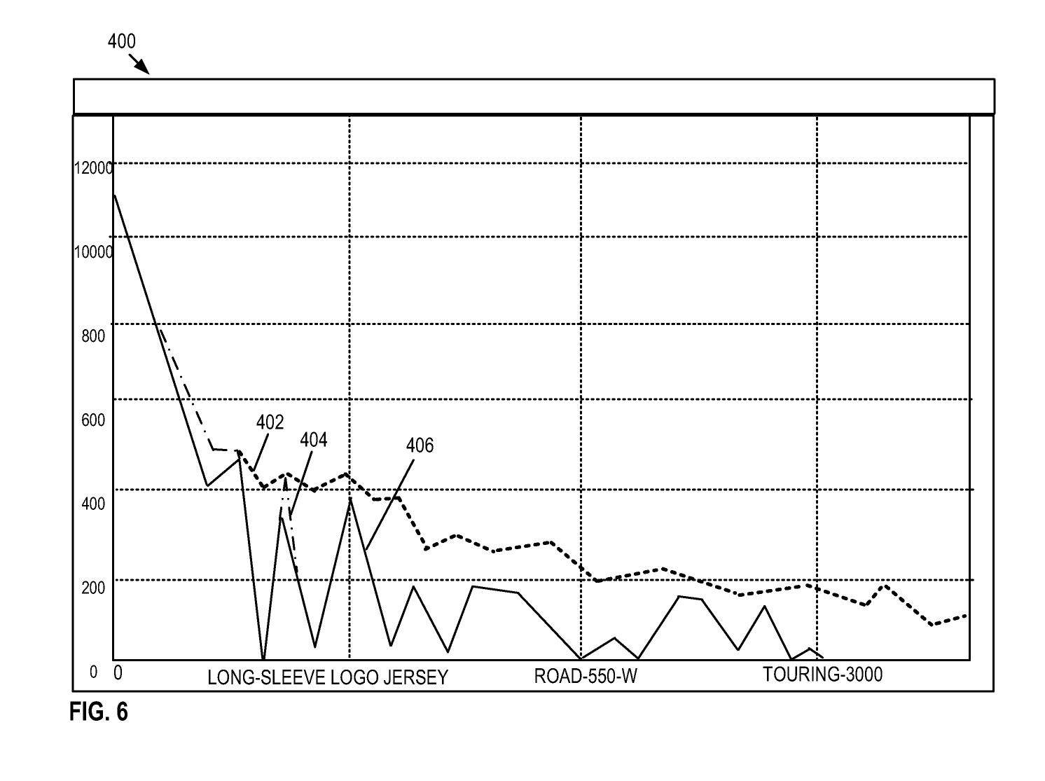

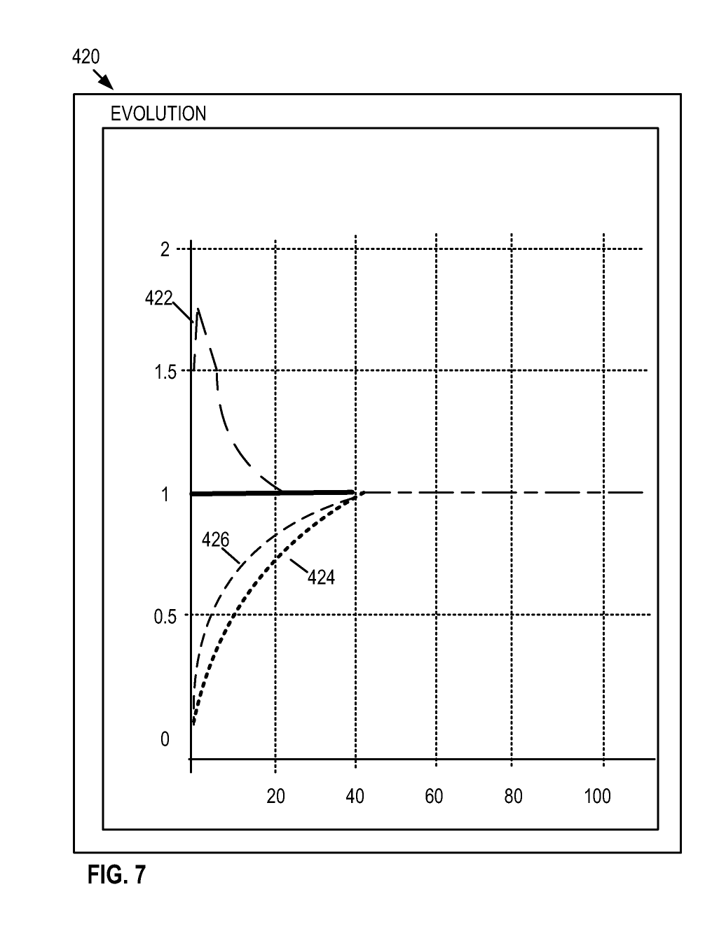

Interactive diagram tool 108 is responsible for displaying an interactive chart that shows the results of the evaluation process 106. Interactive diagram tool 108 is described in further detail in FIGS. 6 and 7.

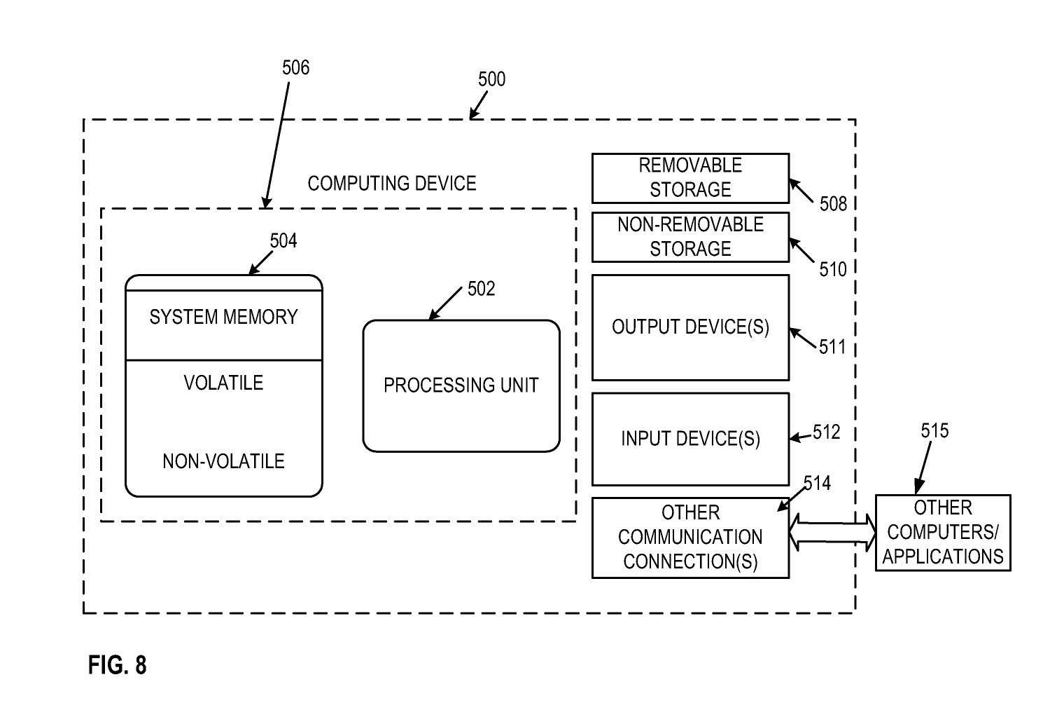

Turning now to FIGS. 2-7, the stages for implementing one or more implementations of system 100 are described in further detail. In some implementations, the processes of FIG. 2-7 are at least partially implemented in the operating logic of computing device 500 (of FIG. 8).

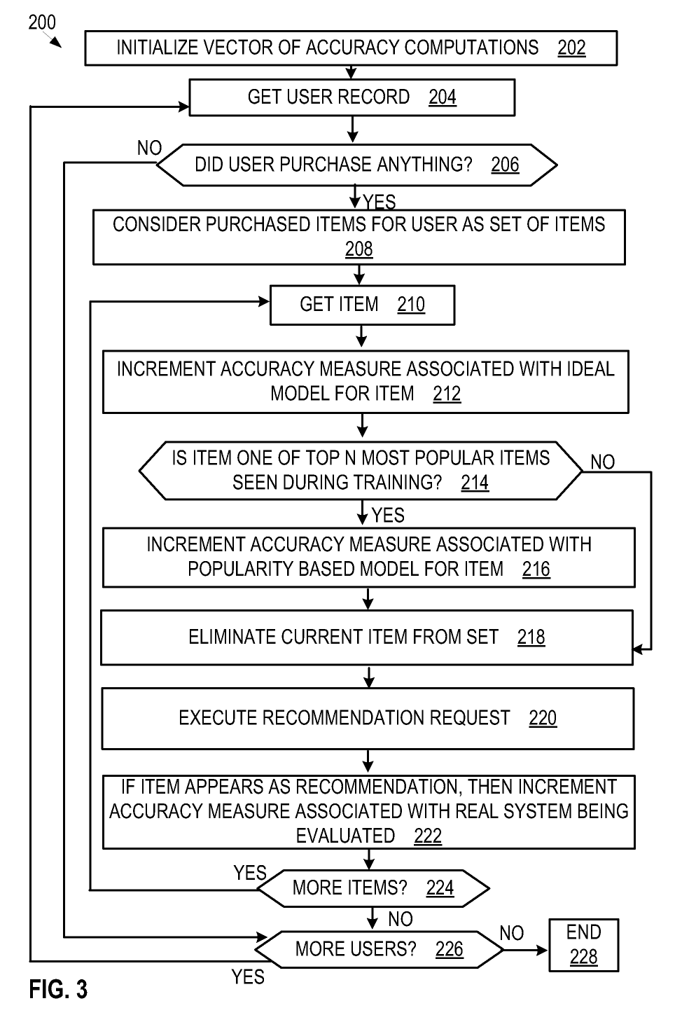

FIG. 2 is a process flow diagram 150 for one implementation illustrating the high level stages involved in calculating measures for multiple recommendation systems so they can be compared. Measures are computed for the real recommendation system being analyzed, for the theoretical ideal system, for the popularity-based baseline system, and optionally for a comparison system (stage 152). As mentioned previously, the accuracy metrics can be computed over the holdout data set (test data set), as is described in further detail in FIGS. 2 and 3. If multiple measures are computed for a given system, then those measures are aggregated (stage 154).

When comparing multiple recommendation systems, one extra computation of the accuracy measure can be added for each item in the item-space (describing the accuracy of the respective recommendation system). In such a scenario, the computation has a fixed parameter, the number of recommendations that the system returns for each request. Consequently, the popularity based system is based on the top N most popular items.

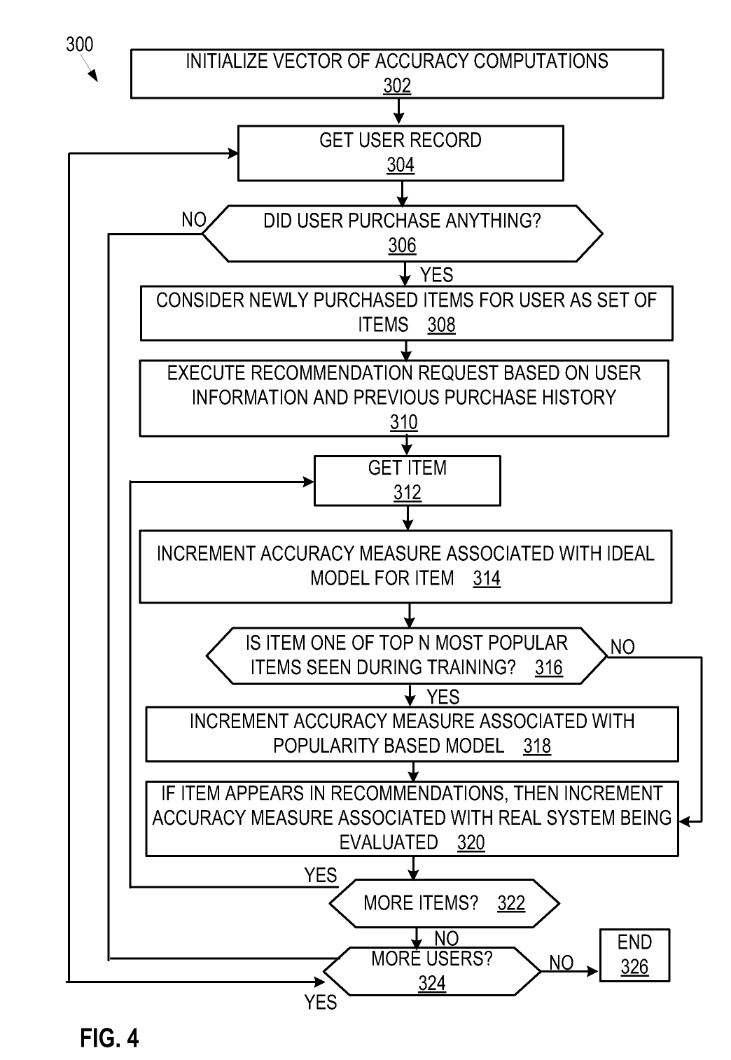

The holdout set can be selected in at least two different ways, and the computation of the accuracy measure depends on the properties of the holdout set. For example, a holdout set can be used that represents a random sample of the data (e.g. prior sales across all customers). Usage of this type of holdout set for computing accuracy measures is described in FIG. 3. As another example, a holdout set can be used that represents new items for existing users (e.g. new purchases by existing customers). Use of this type of holdout set for computing accuracy measures is described in FIG. 4.

Note that in one implementation, in both cases, for the ecommerce metaphor, the holdout set contains users and items purchased by these users (plus, possibly demographic or other information used by the system).

Once the accuracy measures have been calculated, then a graph can be generated in descending order by values of the accuracy measure (stage 156), as is described in further detail in FIG. 6. The user is able to interact with the graph to view more details (stage 158).

FIG. 3 is a process flow diagram 200 for one implementation illustrating the stages involved in using past sales of all customers to assist in generating accuracy metrics for a recommendation system. A vector of accuracy computations is initialized (stage 202). In one implementation, the vector contains as many elements as items in the item set, and each vector item contains 3 measure values (one for the ideal, one for the popularity based and one for the real recommendation system being evaluated). When different actual systems are compared, a new measure value is added for each system. The measure values for all items can be initialized to 0.

A user record is then retrieved (stage 204). If the user did not purchase anything (the item set for the user is empty) (decision point 206), then skip this user and go to the next user, if any (decision point 226). If the user did purchase something (decision point 206), then the item set of the current user is considered as a set of items, S={I1, . . . Ip} (stage 208). An item is retrieved from the item set (I from S) (stage 210). The accuracy measure associated with the ideal model for the item I is incremented (stage 212). Since I actually appeared in the holdout set for the current user, it is a valid recommendation and the ideal system would have made it.

If the item I is one of the top N most popular items in the data seen by the system during training (decision point 214), then the accuracy measure associated with the popularity based model for the item I is incremented (stage 216).

The current item is then eliminated from the set (stage 218), such as by constructing the set as S′=S−{I}. A recommendation request is executed (stage 220) to see what type of recommendation the system will make based on the current items in the set (now that the item has been removed). If the item I appears as a recommendation, then the accuracy measure associated with the real system being evaluated is incremented (stage 222). One reason for incrementing this accuracy measure for the real system is because the current user actually purchased S′ and I. A perfect recommendation system would therefore recommend item I for the current customer, based on S′ and the other customer info.

The next item is retrieved, if any are present (decision point 224), and the stages repeat accordingly to evaluate the additional items for the current user. Once all of the items have been evaluated for the current user (decision point 224), then the next user is retrieved, if any (decision point 226). Once all items have been evaluated for all users, then the process ends at end point 228.

In one implementation, with the process described in FIG. 3, the following evolutions occur for each item accuracy measurement: (1) The ideal measurement grows for each occurrence of an item; (2) The popularity-based measurement grows only for popular items; and (3) The recommendation system's measurement grows only for correct recommendations. The use of another type of holdout set in calculating accuracy measures will now be described in FIG. 4.

Turning now to FIG. 4, a process flow diagram 300 is shown for one implementation illustrating the stages involved in using new purchases by existing customers to assist in generating accuracy metrics for a recommendation system. In one implementation, this process applies when the holdout set consists of new purchases by existing customers that are the same that were used in training the recommendation system. A vector of accuracy computations is initialized (stage 302). In one implementation, the vector contains as many elements as items in the item set, and each vector item contains 3 measure values (one for the ideal, one for the popularity based and one for the real recommendation system being evaluated). When different actual systems are compared, a new measure value is added for each system. The measure values for all items can be initialized to 0.

A user record is retrieved (stage 304), which would be for a user with previous purchases, as used in training the system. If the user did not purchase anything (the item set for the user is empty) (decision point 306), then this user is skipped and the next user record is retrieved, if any (decision point 324).

The item set of the current user is considered as a set of items (stage 308), such as S={I1, . . . Ip} representing the new purchases by that user. A recommendation request is executed based on user's information and previous purchases history (the information used in training the recommendation system) (stage 310). An item I in set S is retrieved (stage 312). The accuracy measure associated with the ideal model for item I is incremented (stage 314). This is because item I actually appeared in the holdout set for the current user, and therefore it is a valid recommendation and the ideal system would have made it. If item I is one of the top N most popular items in the data seen by the system during training (decision point 316), then the accuracy measure associated with the popularity based model for item I is incremented (stage 318)

If item I appears in the recommendations, then the accuracy measure associated with the real system being evaluated is incremented (stage 320). The reason for incrementing the accuracy measure associated with the real system is because the system's recommendation correctly based is accurate. The next item for in the item set for the current user is retrieved (stage 312) and stages repeat accordingly to evaluate the additional items for the current user. Once all of the items have been evaluated for the current user (decision point 322), then the next user is retrieved, if any (decision point 324). Once all items have been evaluated for all users, then the process ends at end point 326.

In one implementation, with the process described in FIG. 4, the following evolutions occur for each item accuracy measurement: (1) The ideal measurement grows for each occurrence of an item; (2) The popularity-based measurement grows only for popular items; and (3) The recommendation system's measurement grows only for correct recommendations.

As noted earlier, depending on the type of holdout set that is available to use in the computations, the process of FIG. 3 or FIG. 4 can be used appropriately.

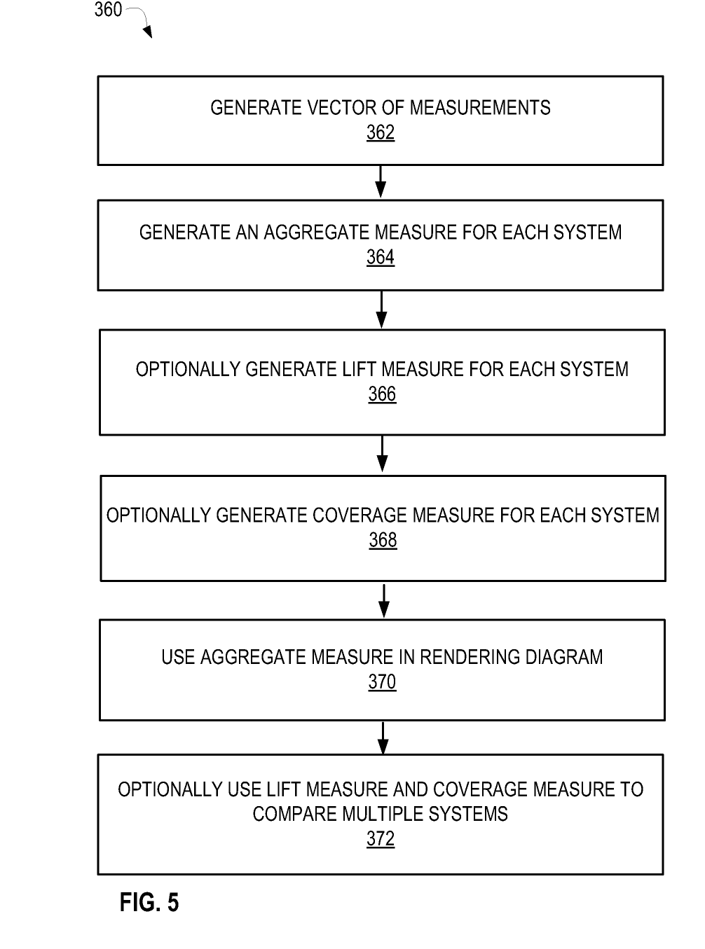

FIG. 5 is a process flow diagram 360 for one implementation illustrating the stages involved in computing overall accuracy scores for recommendation systems. A vector of measurements is generated (stage 362). The vector can contain as many elements as items in the item-space. Each item has at least 3 measurements (ideal system, popularity based system, recommendation system) and possibly more, if multiple systems are evaluated at the same time.

An aggregate measure is defined for each system (including ideal and popularity-based) (stage 364). In one implementation, an aggregate measure is defined for each system using the following formula:

$$A ( System ) = {\sum }_{Item I in \\ item space} Measurement for I$$

In one implementation, after computing the aggregate measure, the following quantities are available:

A_Ideal=A(Ideal System)

A_Popularity=A(Popularity Based System)

A_1=A (Recommendation System 1 being evaluated)

A_i =A(Recommendation System i being evaluated, if multiple systems)

A lift measure (stage 366) and a coverage measure (stage 368) are optionally defined for each recommendation system being evaluated to capture the accuracy and performance information. In one implementation, the lift measure is calculated as follows:

$$Lift ( i ) = \frac{A ( i )}{A\_Popularity}$$

The lift measure provides a ratio of improvement of the accuracy offered by a recommendation system (improvement measured against the baseline provided by the popularity based model) and can be useful in comparing different recommendation systems.

In one implementation, a coverage measure is calculated as follows:

$$Coverage ( i ) = \frac{A ( i )}{A\_Ideal}$$

In one implementation, the coverage measure provides an absolute measure of the accuracy of a system. It can be used in comparing multiple systems, but it is mostly intended as an absolute measure.

In one implementation, the Lift for the popularity based model is 1, and the coverage for the ideal model is also 1.

FIG. 6 is a diagram 400 for one implementation illustrating an interactive chart that presents data regarding the behavior and/or accuracy of a recommendation system as compared with other recommendation systems. Once the measures are calculated according to the techniques described in the earlier figures, an interactive diagram can be created and rendered. The can be sorted in descending order based on the values of the accuracy measure. For each item, the different accuracy measurements are plotted.

Diagram 400 presents the performance of a recommendation system as compared to an ideal and a popularity base one. Curve 402, on top of the other curves, shows the performance of an ideal system. Curve 404 shows the performance of a popularity-based system. Curve 406 represents the performance of the recommendation system to be evaluated. For example, the accuracy measure for a long-sleeve logo jersey is indicated for the ideal system, the system being evaluated, and for the popularity-based system.

The area bounded by one of the curves and the vertical and horizontal axis represents a measure of the overall performance of the recommendation system that generated that curve.

The X (horizontal) axis of the diagram represents the item space. All the items in the space are serialized along this axis, in descending order of the accuracy metric as computed by an ideal recommendation system.

For example, in the ecommerce metaphor, assume that a retailer offers Coca Cola, bread and computer mice. Let's also assume that an ideal system recommends bread 5 times, Coca Cola 3 times and a computer mouse only once. Then the X axis will contain: Bread, Coca Cola, Computer Mouse in this order.

The Y(vertical) axis of the diagram represents the calculated metric for each individual item (from the X-axis).

In the context of the diagram, the overall accuracy of a recommendation system can be assimilated to the area of the curve drawn by the measure over the total item space (effectively, the sum of the accuracy measure computed for the system across the item space).

The sorting of items in descending order on the X-axis displays the item space and the accuracy measures in a form that makes it intuitive to evaluate the “Long tail” distribution (term used in the ecommerce to describe some distributions such as Zipf, Power, Pareto and others).

Once generated, diagram 400 can allow one or more interaction scenarios. Since any point on the X (horizontal) axis represents an item, and the chart contains the various accuracy measurements for that item, by selecting or clicking on a chart, the following information is displayed, which effectively details the behavior of the system for that item (using ML Mountain Tire as a non-limiting example):
Item: “ML Mountain Tire”
Ideal model score: 213 (accuracy measure for the ideal model)
Popularity based model: 0 (this item is not very popular, so a popularity based system would never recommend it)
Your Recommendation System: 114 (the recommendation system achieved an 114 score for this item)

In one implementation, the diagram allows ‘zooming in’ to explore different areas of the distribution of values. In another implementation, the diagram can be computed for a specified number of recommendations (the N parameter in the computation algorithm).

By analyzing the data shown in diagram 400, managers and other users can conduct a performance evaluation of how well their recommendation system is performing, and/or can determine some adjustments to make to the recommendation system. For example, the user can see how one recommendation system performs compared to another (in case the user wishes to switch to the other, for example), whether the system he is already using is providing any value (i.e. are there increased sales and profits based upon the recommendations), and/or a certain item should be kept in inventory because the item is generating profits based upon recommendations from the real recommendation system.

Turning now to FIG. 7, a diagram 420 for one implementation is shown of a chart that illustrates the evolution of the lift 422 and coverage (424 and 426) for a recommendation system. By computing the aggregated measures for various recommendations (N), the evolution of lift and coverage can be displayed graphically for various values of N. Diagram 420 shows, for example how (1) The lift of the recommendation system is small for 1 recommendation, and peaks at 2 recommendations then drops; and (2) The coverage grows with the number of recommendations. This information can be used to determine the optimal number of recommendations a system should produce for each transaction to maximize accuracy of the recommendations with minimum cost deriving from presenting these recommendations to the actual user. For example, a web retailer could use this chart to determine whether to present two or three recommendations to all users.

As shown in FIG. 8, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 8 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 8 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for computing metrics that can be used for analyzing a performance of a recommendation system comprising the steps of:
computing accuracy measures for a plurality of items in a real recommendation system, an ideal recommendation system, and a popularity-based baseline recommendation system; and
presenting the accuracy measures for the plurality of items to a user so the user can evaluate a performance of the real recommendation system in comparison to the ideal recommendation system and the popularity-based baseline recommendation system.

2. The method of claim 1, wherein the accuracy measures are presented in an interactive graph.

3. The method of claim 2, wherein the interactive graph is sorted in descending order by the accuracy measures.

4. The method of claim 2, wherein an area bounded by a curve and the vertical and horizontal axis on the interactive diagram represents a measure of an overall performance of a respective recommendation system that generated the curve.

5. The method of claim 2, wherein the user can select a respective item in the interactive graph to view additional details regarding the respective item.

6. The method of claim 1, wherein the accuracy measures can be analyzed by the user to determine how well the real recommendation system is performing in comparison to the ideal recommendation system and the comparison recommendation system.

7. The method of claim 1, wherein after the accuracy measures are computed, any multiple measures that result are aggregated for a respective recommendation system.

8. The method of claim 1, wherein the accuracy measures are calculated over a holdout data set that is based upon prior sales across all customers.

9. The method of claim 1, wherein the accuracy measures are calculated over a holdout data set that is based upon new purchases by existing customers.

10. A computer-readable medium having computer-executable instructions for causing a computer to perform steps comprising:
computing accuracy measures for a plurality of items in a real recommendation system, an ideal recommendation system, and a popularity-based baseline recommendation system; and
generating a graph that displays the accuracy measures for the plurality of items in the real recommendation system, the ideal recommendation system, and the popularity-based baseline recommendation system.

11. The computer-readable medium of claim 10, further having computer-executable instructions for causing a computer to perform steps comprising:
displaying the accuracy measures in a descending order.

12. The computer-readable medium of claim 10, further having computer-executable instructions for causing a computer to perform steps comprising:
computing accuracy measures for a plurality of items in a comparison recommendation system and including the accuracy measures for the comparison recommendation system in the graph.

13. The computer-readable medium of claim 10, further having computer-executable instructions operable to cause a computer to perform steps comprising:
computing a lift measure for the ideal recommendation system, for the real recommendation system, and for the popularity-based baseline recommendation system.

14. The computer-readable medium of claim 13, further having computer-executable instructions operable to cause a computer to perform steps comprising:
graphically displaying the coverage measure for the ideal recommendation system, for the real recommendation system, and for the popularity-based baseline recommendation system for a user to analyze.

15. The computer-readable medium of claim 10, further having computer-executable instructions operable to cause a computer to perform steps comprising:
computing a coverage measure for the ideal recommendation system, for the real recommendation system, and for the popularity-based baseline recommendation system.

16. The computer-readable medium of claim 15, further having computer-executable instructions operable to cause a computer to perform steps comprising:
graphically displaying the coverage measure for the ideal recommendation system, for the real recommendation system, and for the popularity-based baseline recommendation system for a user to analyze.

17. A method for generating a graph that can be used by a user to conduct a performance evaluation of a real recommendation system comprising the steps of:
computing accuracy measures for a plurality of items in a real recommendation system, an ideal recommendation system, and a popularity-based baseline recommendation system;
generating a graph in descending order by the accuracy measures for the plurality of items in the real recommendation system, the ideal recommendation system, and the popularity-based baseline recommendation system; and
displaying the graph so a user can interact with the graph to conduct a performance evaluation of the real recommendation system in comparison to the ideal recommendation system and the popularity-based baseline recommendation system

18. The method of claim 17, wherein accuracy measures are also computed for a comparison recommendation system.

19. The method of claim 18, wherein the performance evaluation enables the user to determine that the comparison recommendation system is performing better than the real recommendation system.

20. The method of claim 17, wherein the performance evaluation enables the user to determine that a certain item should be kept in inventory because the item is generating profits based upon recommendations from the real recommendation system.
